(19) United States
(12) Patent Application Publication
(10) Pub. No.: US 2015/0147537 A1
(43) Pub. Date: May 28, 2015

(54) COMPOSITE POWDER, PIGMENT PASTE USING THE SAME, AND TOUCH SENSOR

(71) Applicant: SAMSUNG ELECTRO-MECHANICS CO., LTD., Gyeonggi-Do (KR)

(72) Inventors: Tae Kyung LEE, Gyeonggi-Do (KR); Beom Seok OH, Gyeonggi-Do (KR); Deok Seok OH, Gyeonggi-Do (KR)

(73) Assignee: SAMSUNG ELECTRO-MECHANICS CO., LTD., Gyeonggi-Do (KR)

(21) Appl. No.: 14/514,086

(22) Filed: Oct. 14, 2014

(30) Foreign Application Priority Data
Nov. 26, 2013 (KR) 10-2013-0144652

(51) Int. Cl. C09D 17/00; G06F 1/16; C08K 3/36; C08K 3/08; C08K 3/22; G06F 3/041; C09D 175/06

(52) U.S. Cl. CPC C09D 17/002; G06F 3/041; G06F 1/16; C09D 175/06; C08K 3/08; C08K 3/22; C08K 3/36; C08K 2003/0812; C08K 2003/2241
USPC 428/192; 106/404; 524/360

(57) ABSTRACT

Embodiments of the invention provide a composite powder including a core layer disposed at the center thereof and formed of a reflecting material, a first coating layer formed on a surface of the core layer, and a second coating layer formed on a surface of the first coating layer and having a refractive index higher than that of the first coating layer. According to at least one embodiment, high whiteness is more effectively implemented through a bezel in a thin film shape by forming a bezel layer and a reflecting layer of a touch sensor.

### CROSS REFERENCE TO RELATED APPLICATION

This application claims the benefit of and priority under 35 U.S.C. §119 to Korean Patent Application No. KR 10-2013-0144652, entitled “COMPOSITE POWDER, PIGMENT PASTE USING THE SAME, AND TOUCH SENSOR,” filed on Nov. 26, 2013, which is hereby incorporated by reference in its entirety into this application.

### BACKGROUND

1. Field of the Invention

The present invention relates to a composite powder, pigment paste using the same, and a touch sensor.

2. Description of the Related Art

In accordance with the development of computers using a digital technology, devices assisting computers have also been developed, and personal computers, portable transmitters, and other personal information processors execute processing of text and graphics using a variety of input devices, such as a keyboard and a mouse, as non-limiting examples.

While the rapid advancement of an information-oriented society has been widening the use of computers more and more, it is difficult to efficiently operate products using only a keyboard and mouse currently serving as an input device. Therefore, the necessity for a device that is simple, has less malfunction, and is capable of easily inputting information has increased.

In addition, current techniques for input devices have progressed toward techniques related to high reliability, durability, innovation, designing and processing beyond the level of satisfying general functions, or the like. To this end, a touch sensor has been developed as an input device capable of inputting information, such as text or graphics, as non-limiting examples.

The conventional touch sensor is mounted on a display surface of an image display device, such as an electronic note, a flat panel display device including a liquid crystal display (LCD) device, a plasma display panel (PDP), an electroluminescence (El), as non-limiting examples, or a cathode ray tube (CRT) to thereby be used to allow a user to select desired information while viewing the image display device.

Meanwhile, the touch sensor is classified into a resistive type touch sensor, a capacitive type touch sensor, an electromagnetic type touch sensor, a surface acoustic wave (SAW) type touch sensor, and an infrared type touch sensor. These various types of touch sensors are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch sensor and the capacitive type touch sensor have been prominently used in a wide range of fields.

As an example of the touch sensor as described above, a touch sensor may have a structure in which a transparent substrate and a sensor are adhered to each other via an adhesive, and a touch sensor may be formed so that a bezel part formed along an edge of a transparent substrate shields a bus line of a sensor, as described, for example, in Korean Patent Publication No. KR 2013-0017898.

Recently, an exterior design is a growing importance in information technology (IT) devices, and a size of a display screen has been increased. In order to increase the size of the display screen without increasing a size of an appearance of the device and implement full colors that are close to the original colors, an effort for further decreasing an area or thickness of a bezel part has been conducted.

However, the area or thickness of the bezel part may be changed according to a color of the bezel part to be implemented. Particularly, in the case of bright tone colors through which light easily passes such as white, in order to minimize transmission of light, the thickness of the bezel part should be increased, which runs counter to the trend toward miniaturization and thinness of the IT device.

### SUMMARY

Accordingly, embodiments of the invention have been made to provide a composite powder capable of effectively improving whiteness by including a core layer and a second coating layer made of a reflecting material and a first coating layer formed between the core layer and the second coating layer and having a different refractive index from that of the second coating layer.

In addition, embodiments of the invention have been made in an effort to provide a touch sensor capable of effectively implementing bright colors of a bezel layer even in the case of a thin thickness and improving whiteness by forming the bezel layer on a window substrate using the composite powder and forming a reflecting layer on the bezel layer and an interposing layer between the bezel layer and the reflecting layer.

According to an embodiment of the invention, there is provided a composite powder including a core layer formed at the center thereof, a first coating layer formed on a surface of the core layer, and a second coating layer formed on a surface of the first coating layer and having a refractive index higher than that of the first coating layer.

According to at least one embodiment, diameters of the core layer and the first and second coating layers are 300 to 500 nm.

According to an embodiment of the invention, a thickness of the first coating layer is 10 to 40% of a thickness of the formed second coating layer.

According to an embodiment of the invention, the core layer has a diameter of 50 to 100 nm.

According to an embodiment of the invention, reflectivity of the core layer is 60 to 99%.

According to an embodiment of the invention, the core layer is formed of any one selected from titanium (Ti), aluminum (Al), nickel (Ni), silver (Ag), chromium (Cr), platinum (Pt), molybdenum (Mo), copper (Cu), gold (Au), tungsten (W), iridium (Ir), and a combination thereof.

According to an embodiment of the invention, the first coating layer is formed on the surface of the core layer at a thickness of 20 to 100 nm.

According to an embodiment of the invention, a transmittance of the first coating layer in a visible light region is 30 to 99%.

According to an embodiment of the invention, a refractive index of the first coating layer is 1.2 to 2.

According to an embodiment of the invention, the first coating layer is formed of SiO₂, SiNx, silane based compounds, or a combination thereof.

According to an embodiment of the invention, the first coating layer is formed of an oxide of any one selected from titanium (Ti), aluminum (Al), nickel (Ni), silver (Ag), chromium (Cr), platinum (Pt), molybdenum (Mo), copper (Cu), gold (Au), tungsten (W), iridium (Ir), and a combination thereof.

According to an embodiment of the invention, the second coating layer is formed on the surface of the first coating layer at a thickness of 150 to 300 nm.

According to an embodiment of the invention, the reflectivity of the second coating layer in a visible light region is 50 to 95%.

According to an embodiment of the invention, the reflectivity of the second coating layer in a visible light region is 75 to 90%.

According to an embodiment of the invention, the refractive index of the second coating layer is 2 to 3.

According to an embodiment of the invention, the second coating layer is formed of any one selected from titanium dioxide (TiO₂), hafnium oxide (HfO₂), and a combination thereof, or any one selected from zinc oxide (ZnO), magnesium oxide (MgO), cerium oxide (ceria; Ce₂O₃), indium oxide (In₂O₃), indium tin oxide (ITO), barium titanate (BaTiO₃), potassium tantalate (KTaO₃), (Ba,Sr)TiO₃, and a combination thereof.

According to another embodiment of the invention, there is provided a pigment paste including a resin composition, and the composite powder formed according to the embodiment of the invention discussed above, and dispersed in the resin composition.

According to an embodiment of the invention, 0.1 to 90.0 parts by weight of the composite powder is dispersed in the resin composition.

According to an embodiment of the invention, the resin composition further includes a binder, a solvent, and an additive.

According to an embodiment of the invention, the binder is any one selected from a phenol resin, an epoxy resin, a melamine resin, a urea resin, a polyphenylene ether resin, a polyester resin, a polyurethane resin, a polyimide resin, a polyamide resin, a nylon resin, a polybutylene terephthalate resin, a polycarbonate resin, a polyethylene resin, a polypropylene resin, a polychloride resin, a silicon resin, a polystyrene resin, a Teflon resin, a polysulfone resin, a polyestersulfone resin, an acrylonitrile-butadiene-styrene (ABS) resin, and a polyacrylic resin.

According to an embodiment of the invention, the solvent is any one selected from diethylene glycol monobutyl ether (DGME), polyvinylbutyral (PVB), and terpineol.

According to another embodiment of the invention, there is provided a touch sensor including a window substrate, and a bezel layer formed at an edge portion of the window substrate and containing the composite powder formed according to the embodiment of the invention discussed above.

According to an embodiment of the invention, the touch sensor further includes a reflecting layer formed on the bezel layer, and an interposing layer between the bezel layer and the reflecting layer. According to an embodiment of the invention, the interposing layer is formed of a material having a refractive index lower than that of the bezel layer.

According to an embodiment of the invention, a lamination thickness of the bezel layer, the reflecting layer, and the interposing layer is 2 to 50 μm.

According to an embodiment of the invention, a thickness of the bezel layer is 1 to 20 μm.

According to an embodiment of the invention, reflectivity of the bezel layer in a visible light region is 50 to 95%.

According to an embodiment of the invention, reflectivity of the bezel layer in a visible light region is 75 to 90%.

According to an embodiment of the invention, a refractive index of the bezel layer is 2 to 3.

According to an embodiment of the invention, a thickness of the interposing layer is 10 to 40% of a thickness of the bezel layer.

According to an embodiment of the invention, a thickness of the interposing layer is 1 to 8 μm.

According to an embodiment of the invention, the interposing layer is formed of any one selected from a transparent acrylic resin, a silicon based resin, and an epoxy resin, and a combination thereof.

According to an embodiment of the invention, the interposing layer is formed of any one selected from SiO₂, SiNx, silane based compounds, and a combination thereof as the silicon based resin.

According to an embodiment of the invention, the interposing layer is formed of an oxide of any one selected from titanium (Ti), aluminum (Al), nickel (Ni), silver (Ag), chromium (Cr), platinum (Pt), molybdenum (Mo), copper (Cu), gold (Au), tungsten (W), iridium (Ir), and a combination thereof.

According to an embodiment of the invention, a transmittance of the interposing layer in a visible light region is 30 to 99%.

According to an embodiment of the invention, a refractive index of the interposing layer is 1.2 to 2.

According to an embodiment of the invention, a thickness of the reflecting layer is 1 to 20 μm.

According to an embodiment of the invention, reflectivity of the reflecting layer is 60 to 99%.

According to an embodiment of the invention, the reflecting layer is formed of any one selected from titanium (Ti), aluminum (Al), nickel (Ni), silver (Ag), chromium (Cr), platinum (Pt), molybdenum (Mo), copper (Cu), gold (Au), tungsten (W), iridium (Ir), and a combination thereof.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a cross-sectional view of composite powder according to an embodiment of the invention.

FIG. 2 is a partially enlarged view of the composite powder according to another embodiment of the invention.

FIG. 3 is a view showing a method of preparing a composite powder according to another embodiment of the invention.

FIG. 4 is a view showing a pigment paste containing a composite powder according to another embodiment of the invention.

FIG. 5 is a view showing a touch sensor using a pigment paste containing a composite powder according to another embodiment of the invention.

FIG. 6 is a graph showing measured whiteness of samples according to another embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

Hereinafter, various embodiments of the present invention will be described in detail with reference to the accompanying drawings.

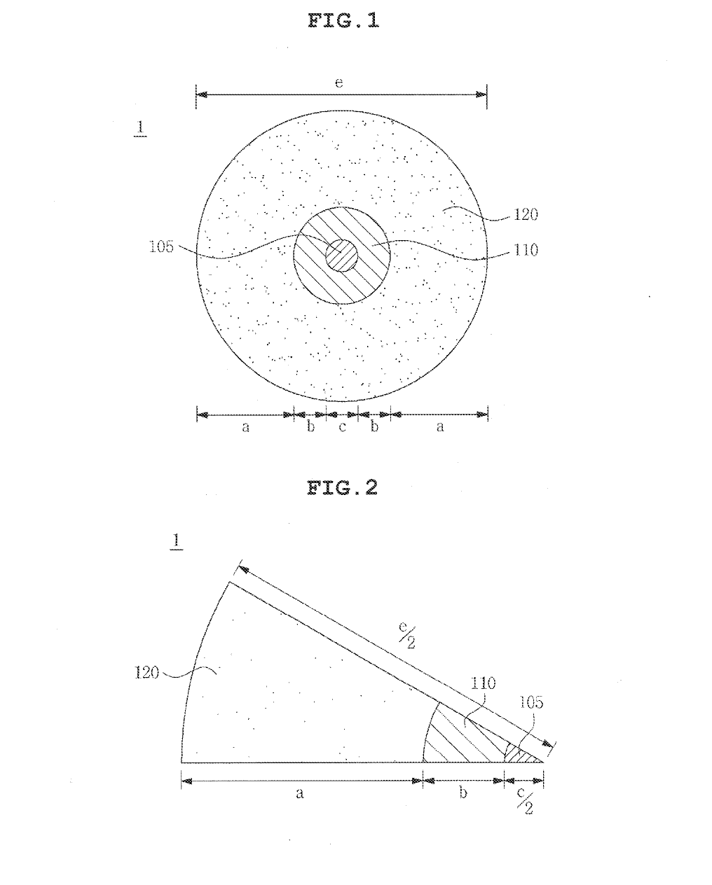

FIG. 1 is a cross-sectional view of composite powder according to an embodiment of the invention, and FIG. 2 is a partially enlarged view of the composite powder according to another embodiment of the invention.

Referring to FIGS. 1 and 2, the composite powder 1, according to an embodiment of the invention, includes a core layer 105 disposed at the center thereof, a first coating layer 110 formed on a surface of the core layer 105, and a second coating layer 120 formed on a surface of the first coating layer 110. According to at least one embodiment, the core layer 105 is made of a reflecting material, and the second coating layer 120 is formed to have a refractive index higher than that of the first coating layer 110.

According to at least one embodiment, the composite powder 1 is formed as a spherical particle having a diameter E of 300 to 500 nm. Hereinafter, the case in which the composite powder 1 has an identical spherical shape by way of example, but the shape of the composite powder 1 is not limited to the spherical shape.

According to at least one embodiment, the core layer 105 is formed using the reflecting material. The core layer 105 is formed using a reflecting material having reflectivity of 60 to 99%. For example, the coating layer 105 is formed of titanium (Ti), aluminum (Al), nickel (Ni), silver (Ag), chromium (Cr), platinum (Pt), molybdenum (Mo), copper (Cu), gold (Au), tungsten (W), iridium (Ir), and a combination thereof.

According to at least one embodiment, the core layer 105 is formed to have a diameter c of 50 to 100 nm. Thus, a radius c/2 of the core layer is 25 to 50 nm. According to at least one embodiment, in the case in which the diameter of the core layer 105 is 50 nm or less, it is difficult to form powder of the core layer 105, and in the case in which the diameter of the core layer 105 is 100 nm or more, it is difficult to form the composite powder 1 including the core layer 105 to obtain the desired white color as its own color.

According to at least one embodiment, the first coating layer 110 has a thickness of 20 to 100 nm on the surface of the core layer 105. The first coating layer 110 is made of a low refractive index material b having a refractive index lower than that of the second coating layer 120.

According to at least one embodiment, the refractive index of the first coating layer 110 is 1.2 to 2, and transmittance of the first coating layer 110 is 30 to 99% in a visible light region. For example, the first coating layer 110 is made of SiO₂, SiNx, silane based compounds, and a combination thereof, wherein the silane based compounds, for example, are transparent materials having a refractive index of 1.2 to 1.6 and transmittance of 30 to 99% in the visible light region.

Further, according to at least one embodiment, the first coating layer 110 is formed as an oxide film by surface-treating the surface of the core layer 105. Here, the oxide film, which is the first coating layer 110, is formed to have a refractive index of 1.5 to 1.9. The coating layer 110 is formed of an oxide of any one selected from titanium (Ti), aluminum (Al), nickel (Ni), silver (Ag), chromium (Cr), platinum (Pt), molybdenum (Mo), copper (Cu), gold (Au), tungsten (W), iridium (Ir), and a combination thereof. According to at least one embodiment, a thickness of the oxide film is adjusted by adjusting an oxidation time and an oxidation condition.

For example, the first coating layer 110 is formed by a method of putting aluminum (Al) powder of the core layer 105 into water and heating at a temperature close to a boiling point of water to oxidize a surface of the aluminum powder. In this case, the Reaction Formula is as follows: 2Al+3H₂O=Al₂O₃+3H₂.

Alternatively, according to another method, the first coating layer 110 is formed by a method of heating the aluminum (Al) powder of the core layer 105 under oxygen atmosphere to oxidize the surface of the aluminum powder. In this case, the Reaction Formula is as follows: 2Al+3O₂=Al₂O₃.

In this case, the first coating layer 110 formed as the oxide film has a refractive index of 1.6 to 1.8.

According to at least one embodiment, the second coating layer 120 is formed on the surface of the first coating layer 110. The second coating layer 120 is formed as a high refractive index layer as compared to the first coating layer 110.

According to at least one embodiment, the second coating layer 120 is formed using a material having a refractive index of 2 to 3 and reflectivity of 50 to 95%, more specifically 75 to 90% in the visible light region. For example, the second coating layer 120 is formed of any one selected from titanium dioxide (TiO₂), hafnium oxide (HfO₂), or a combination thereof. Further, the second coating layer 120 is formed of any one selected from zinc oxide (ZnO), magnesium oxide (MgO), cerium oxide (ceria; Ce₂O₃), indium oxide (In₂O₃), indium tin oxide (ITO), barium titanate (BaTiO₃), potassium tantalate (KTaO₃), (Ba,Sr)TiO₃, or a combination thereof.

In addition, a thickness a of the second coating layer 120 is 150 to 300 nm. In the case in which the thickness of the second coating layer 120 is 150 nm or less, whiteness is deteriorated, and in the case in which the thickness is 300 nm or more, it is not easy to form powder finally having a three layer structure, and inherent whiteness is deteriorated in the visible light region.

Therefore, the first coating layer 110 is formed so that the thickness is 10 to 40% the thickness of second coating layer 120. Thus, by calculating the thickness ratio, the first coating layer 110, which is the low refractive index layer, is formed to have the thickness of 20 to 100 nm. According to at least one embodiment, the thickness b of the first coating layer 110 is 20 nm or less, a scattering effect with the second coating layer 120, which is a high refractive index layer, is decreased, and in the case in which the thickness b is 100 nm or more, the layer having a low refractive index is widened, such that it is difficult to implement bright colors due to a decrease in whiteness.

According to at least one embodiment, the composite powder 1 configured of the first and second coating layers 110 and 120 and the core layer 105 formed as described above implement vivid whiteness due to a difference in refractive index according to the following Equation.

$$n = \frac{c}{υ}$$

According to at least one embodiment, n indicates a refractive index, c indicates a speed of light in the air, and ν indicates a speed of light in a medium.

For example, titanium oxide (TiO₂) used as the second coating layer 120 is an oxide and has a refractive index of 2.5 to 2.9, and silicon oxide (SiO₂) used as the first coating layer 110 has a refractive index of about 1.4. Thus, there is a difference in the refractive index between the first coating layer 110, which is the low refractive index layer, and the second coating layer 120, which is the high refractive index layer, such that scattering of light is generated.

According to at least one embodiment, the refractive index physically means a relative speed of incident light, and the refractive index is high, means that the speed of light is decreased in the medium. Therefore, the higher the refractive index, the longer the time for which light remains in the medium, such that reflection or scattering is increased.

Describing in detail, when light scattered while remaining in the second coating layer 120, which is the high refractive index layer, meets the first coating layer 110, which is the low refractive index layer, a part of the light is reflected at an interface between the first coating layer 110 and the second coating layer 120 to thereby be incident on the second coating layer 120.

According to at least one embodiment, another part of the light is refracted into the first coating layer 110, while increasing the speed thereof as the high refractive index medium is changed into the low refractive index medium. The refracted light is not scattered and reflected due to the low refractive index of the first coating layer 110, but meets the core layer 105. According to at least one embodiment, since the core layer 105 is made of the reflecting material, the light reaching the core layer 105 is reflected again to thereby pass through the first coating layer 110 and be incident on the second coating layer 120, which is the high refractive index layer.

Therefore, light discharged from the second coating layer 120 passes through the first coating layer 110, which is the low refractive index layer, to thereby reach the core layer 105. According to at least one embodiment, the light reaching the core layer 105 is reflected to thereby be incident again on the second coating layer 120, such that light scattered in the second coating layer 120 is further increased. Therefore, since the scattered light is increased as the light discharged from the second coating layer 120 is reflected again at the core layer 105 to thereby be incident on the inside of the second coating layer 120, the composite powder 1 according to the invention implements bright colors of which whiteness is improved.

As described above, in the composite powder 1, scattering of visible light is improved by interposing the first coating layer 110, which is the low refractive index layer, between the core layer 105 made of the reflecting material at the center and the second coating layer 120, which is the high refractive index layer, and bright colors of which whiteness is improved is implemented due to a reflection effect of the core layer 105.

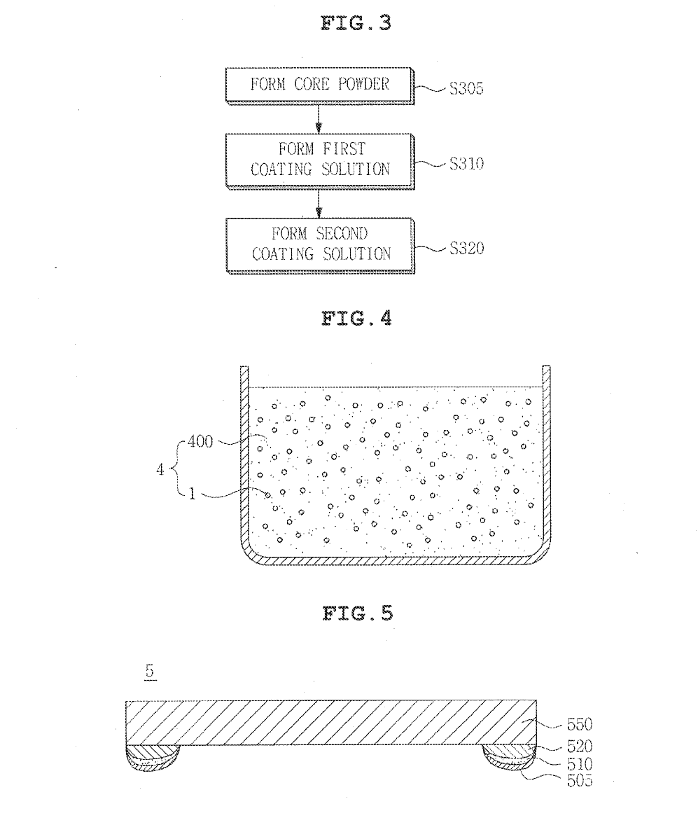

FIG. 3 is a view showing a method of preparing the composite powder according to an embodiment of the invention. Here, in order to avoid an overlapped description of the composite powder, the description will be provided with reference to FIGS. 1 and 2.

Referring to FIG. 3, in the method of preparing a composite powder 1 according to an embodiment of the invention, core power capable of being used as the core layer 105 is formed (S305).

According to at least one embodiment, as the core powder, which is a material having a reflection property, a material having reflectivity ranging from 60% to less than 99% is selected. For example, the core powder is formed of any one selected from titanium (Ti), aluminum (Al), nickel (Ni), silver (Ag), chromium (Cr), platinum (Pt), molybdenum (Mo), copper (Cu), gold (Au), tungsten (W), iridium (Ir), and a combination thereof. In this embodiment, the case in which aluminum powder is used as the core powder is described by way of example. According to at least one embodiment, the core powder made of the aluminum powder has a size of 50 to 100 nm and a spherical shape.

According to at least one embodiment, in order to form the first coating layer 110 on the surface of the core layer 105, a first coating solution is formed (S310). First, an aqueous solution capable of dispersing the core powder is prepared, and the aluminum powder, which is the core powder is dispersed in the aqueous solution, thereby forming slurry. According to at least one embodiment, 1 to 5 parts by weight of the core powder is dispersed in the slurry.

In addition, 15 to 25 parts by weight of tetraethoxysilane (TEOS)-ethanol solution is added to the slurry in which the aluminum powder is dispersed, thereby forming the first coating solution. According to at least one embodiment, the first coating solution has a pH of 10 to 12 and be stirred at 50 to 75° C.

According to at least one embodiment, the first coating solution forms the first coating layer 110 formed of silicon oxide (SiO₂) through hydrolysis. According to at least one embodiment, the first coating layer 110 formed of silicon oxide has a refractive index of 1.2 to 1.6.

Meanwhile, the first coating layer 110 is formed as an oxide film on the surface of the core layer 105. As in the Examples, the first coating layer 110 formed of the oxide film is formed by oxidizing the surface of the aluminum powder forming the core layer 105. According to at least one embodiment, the oxide film, for example, aluminum oxide (Al₂O₃) is formed to have a refractive index of 1.5 to 1.9.

According to at least one embodiment, a second coating solution is formed to form the second coating layer 120 on a surface of the powder in which the first coating layer 110 is formed on the surface of the core layer 105 (S320). Describing in detail, as the second coating solution, an aqueous solution of an inorganic acid salt is formed.

For example, as the second coating layer 120, an aqueous solution of an inorganic acid salt (for example, of the titanyl sulfate) of titanium is prepared, and titanium dioxide hydrate is precipitated on surfaces of core particles of the first coating layer 110 in the aqueous solution of the inorganic salt of titanium. Thereafter, the second coating layer 120 is formed by heating the titanium dioxide hydrate in the air.

Alternatively, the second coating layer 120 is formed by hydrolyzing and firing titanium alkoxide, while contacting titanium alkoxide and the core particles of the first coating layer 110 in a solvent of the inorganic acid salt of titanium.

Meanwhile, in the case of selecting cheap titanium oxide as a coating component at the time of forming the second coating layer 120, the second coating layer is formed, for example, by a method of heating and reducing the powder coated with the prepared titanium dioxide as described above at 500 to 1000° C. or 700 to 900° C. with a reducible flame using gas having reducing powder.

According to at least one embodiment, as the gas having reducing power, hydrogen gas, ammonia gas, as non-limiting examples, is used, and a mixed gas of the gas having reducing power and inert gas such as helium gas, argon gas, nitrogen gas, as non-limiting examples, is used.

According to at least one embodiment, in the case in which light is transmitted through the composite powder 1 prepared so that the first coating layer 110, which is the low refractive index layer, is interposed between the core layer 105 made of the reflecting material at the center and the second coating layer 120, which is the high refractive index layer, the composite powder 1 implements bright colors of which whiteness is improved due to the reflection effect of the core layer 105 and an increase in the scattering of the light caused by the difference in the refractive index.

FIG. 4 is a view showing a pigment paste containing the composite powder according to an embodiment of the invention. Here, in order to avoid an overlapped description of the composite powder 1, the description will be provided, based on FIGS. 1 to 3.

Referring to FIG. 4, the pigment paste 4, according to another embodiment of the invention, includes a resin composition 400 and the composite powder 1 dispersed in the resin composition 400. In order to facilitate formability of the composite powder 1, for example, the pigment paste 4 in a paste state is formed by mixing the composite powder 1 with the resin composition 400.

According to at least one embodiment, the composite powder 1 is formed to include the core layer 105, the first coating layer 110, and the second coating layer 120, as shown in FIGS. 1 to 3. The composite powder is formed of plural layers, such that the scattering of light is increased due to the difference in the refractive index, and the core layer 105 increases the reflection effect, such that whiteness is improved.

According to at least one embodiment, the composite powder 1 is dispersed in the resin composition 400, and an amount of the composite powder 1 mixed with the resin composition 400 is not particularly limited, but 0.1 to 90.0 parts by weight of the composite powder 1, for example, is mixed based on 100 parts by weight of the pigment paste 4.

According to at least one embodiment, as the resin composition 400, a combination of a binder, a solvent, additives, as non-limiting examples, is used. In this case, since viscosity, for example, is adjusted by adjusting the content of the composite powder 1, contents of the binder, solvent, and additives are not particularly limited.

According to at least one embodiment, as the binder, for example, any one selected from a phenol resin, an epoxy resin, a melamine resin, a urea resin, a polyphenylene ether resin, a polyester resin, a polyurethane resin, a polyimide resin, a polyamide resin, a nylon resin, a polybutylene terephthalate resin, a polycarbonate resin, a polyethylene resin, a polypropylene resin, a polyvinylchloride resin, a silicon resin, a polystyrene resin, a Teflon resin, a polysulfone resin, a polyestersulfone resin, an acrylonitrile-butadiene-styrene (ABS) resin, and a polyacrylic resin is used.

According to at least one embodiment, as the solvent, for example, any one selected from diethylene glycol monobutyl ether (DGME), polyvinylbutyral (PVB), and terpineol is used.

According to at least one embodiment, the additives include, for example, a surfactant, a dispersant, a UV absorber, a weather-resistant agent, an antioxidant, an antistatic agent, a flame retardant, other agents, as non-limiting examples. According to at least one embodiment, as the surfactant, for example, diethylene glycol monobutyl ether acetate (DGMEA), as non-limiting examples, is used. According to at least one embodiment, since the composite powder has a powder shape having a nano size, such that surface energy of the composite powder is in a high state. Therefore, a coagulation phenomenon is generated. In order to solve this coagulation problem, the composite powder is uniformly distributed by using the dispersant.

As described above, products using the pigment paste 4 containing the composite powder, for example, a cosmetic product, paint, a brightener, a printing ink composition, as non-limiting examples, implement bright colors of which whiteness is improved due to the core layer 105 of the composite powder 1 increasing the reflection effect to thereby increase the scattering of the visible light.

FIG. 5 is a view showing a touch sensor using a pigment paste containing the composite powder according to another embodiment of the invention. According to at least one embodiment, in order to avoid an overlapped description of the composite powder 1 and the pigment paste 4, the description will be provided, based on FIGS. 1 to 4.

According to at least one embodiment, the pigment paste 4 containing the composite powder 1 is used in various fields, such as cosmetics, paints, printing ink compositions, as non-limiting examples, and among them, as one embodiment, a touch sensor will be described.

Referring to FIG. 5, according to at least one embodiment of the invention, the touch sensor 5 includes a window substrate 550, a bezel layer 520 formed at an edge portion of the window substrate 550, and the composite powder 1 described with reference to FIGS. 1 and 2, a reflecting layer 505 formed on the bezel layer 520, and an interposing layer 510 interposed between the bezel layer 520 and the reflecting layer 505. According to at least one embodiment, the interposing layer 510 is made of a material having a refractive index lower than that of the bezel layer 520.

According to at least one embodiment, the window substrate 550 is formed on the outermost portion of the touch sensor 5 and simultaneously serves to protect the touch sensor 5 from an external environment. According to at least one embodiment, the window substrate is made of a transparent material for visibility of a user, and a material of the window substrate is not particularly limited as long as the material has strength capable of protecting the touch sensor 5 as a material having predetermined strength or more, such as glass or tempered glass. For example, the window substrate is formed of one selected from the group consisting of a polyethylene terephthalate (PET) film, a polycarbonate (PC) film, a polymethylmethacylate (PMMA) film, a polyethylene naphthalate (PEN) film, a polyethersulfone (PES) film, a cyclic olefin polymer (COC) film, a triacetylcellulose (TAC) film, as non-limiting examples.

According to at least one embodiment, the touch sensor 5 includes an active area A at which images are displayed and a touch is recognized and a non-active area (hereinafter, referred to as a bezel area B) formed at an edge portion of the active area A, wherein the bezel area B is formed in order to shield an electrode wiring, as a non-limiting example.

In an application example of the present invention, an electrode pattern (not shown) is directly formed on the window substrate 550 together with the bezel layer 520 formed on the window substrate 550, such that the touch sensor 5 is thinned and miniaturized, and touch sensitivity is improved. However, it is obvious to those skilled in the art that the touch sensor selectively has various structures in which an electrode pattern is formed on a separate base substrate and coupled to the window substrate 550 in addition to the structure in which the electrode pattern is directly formed on the window substrate 550.

According to at least one embodiment, the bezel layer 520 is formed at the bezel area B to improve visibility and external appearance characteristics of the touch sensor 5 by implementing vivid colors in various devices including the touch sensor 5. According to at least one embodiment, the bezel layer 520 is formed of a plurality of layers.

According to at least one embodiment, the bezel layer 520 is formed using the pigment paste 4 containing the composite powder 1 as described with reference to FIGS. 1 to 4. Since the pigment paste 4 is in the paste state, the bezel layer 520 is formed by coating the pigment paste 4 onto the window substrate 550, pushing the pigment paste using a squeegee, as non-limiting examples, and then performing the screen printing on the bezel area B.

Alternatively, the composite powder 1 is sintered, and the bezel layer 520 is formed using a sintering material made of the composite powder 1 as a target. The target is provided to a sputter, such that the bezel layer 520 is formed by a sputtering method.

According to at least one embodiment, the bezel layer 520 is formed at a thickness of 1 to 20 μm. In addition, the bezel layer 520 is made of a material having reflectivity at 50 to 95% or 75 to 85%.

Further, the bezel layer 520 using the composite powder 1 has whiteness of 80 to 85 in spite of being a single layer. According to at least one embodiment, the bezel layer 520 using the composite layer 1 as in FIGS. 1 to 4 is formed to have a refractive index of 2 to 3. In addition, in the single bezel layer 520 using the composite powder 1, the composite powder is formed of the core layer 105 made of the reflecting material, the first coating layer 110 having a low refractive index, and the second coating layer 120 having a high refractive index, such that the reflectivity is increased, and scattering of light is increased due to the difference in the refractive index, thereby making it possible to improve whiteness of the bezel layer 520.

As described above, the composite powder 1 forming the bezel layer 520 used in the touch sensor 5 according to the application embodiment of the invention further improves whiteness as compared to single powder of generally used titanium oxide, such that the composite powder 1 also implements bright colors in the single layer. Therefore, in the touch sensor 5 according to the application embodiment of the invention, the touch sensor 5 also implements bright colors in the single layer, such that the thickness of the bezel layer 520 is decreased.

According to at least one embodiment, the touch sensor 5 according to the application embodiment of the invention includes a reflecting layer 505 to improve whiteness.

According to at least one embodiment, the reflecting layer 505 is formed at a thickness of 1 to 20 μm. In addition, the reflecting layer 505 is formed to have reflectivity at 60 to 99%. In order to increase reflection efficiency as described above, the reflecting layer 505 is formed of, for example, any one selected from titanium (Ti), aluminum (Al), nickel (Ni), silver (Ag), chromium (Cr), platinum (Pt), molybdenum (Mo), copper (Cu), gold (Au), tungsten (W), iridium (Ir), and a combination thereof.

Meanwhile, the interposing layer 510 is interposed between the bezel layer 520 and the reflecting layer 505. According to at least one embodiment, the interposing layer 510 is formed of a low refractive index layer as compared to the bezel layer 520 and has a thickness of 1 to 8 μm. According to at least one embodiment, the thickness of the interposing layer 510 is 10 to 40% of the thickness of the bezel layer 520.

According to at least one embodiment, the bezel layer 520 on the bezel area B implements bright colors using a refractive index in the visible light region, transmittance, and a variable of the thickness. According to at least one embodiment, the interposing layer 510 is interposed between the bezel layer 520 and the reflecting layer 505, such that even in the case in which light transmits through the bezel layer 520, the transmitted light is reflected in the reflecting layer 505 by the difference in the refractive index to thereby be incident on the bezel layer 520. Therefore, the light scattered in the bezel layer 520 is increased, which increases whiteness of the bezel area B, thereby making it possible to implement bright colors.

To this end, the interposing layer 510 is formed using a transparent material. According to at least one embodiment, the interposing layer 510 is formed of a transparent material having a transmittance of 30 to 99% in the visible light region. According to at least one embodiment, the interposing layer 510 is formed of any one transparent resin selected from an acrylic resin, a silicon based resin, an epoxy resin, and a combination thereof, so that a refractive index thereof is different from that of the bezel layer 520 and is 1.2 to 2.

According to at least one embodiment, the acrylic resin is an acrylic copolymer resin, and at least one selected from acrylonitrile, alkylacrylate, butylacrylate, 2-ethylhexylacrylate, t-butylacrylate, n-octylacrylate, acrylic acid, methacrylic acid, itaconic acid, 4-hydroxybutylacrylate, 2-hydroxyethyl(meth)acrylate, 2-hydroxyethyleneglycol(meth)acrylate, and 2-hydroxypropyleneglycol(meth)acrylate is used.

As the epoxy resin, at least one selected from a naphthalene based epoxy resin, a bisphenol A type epoxy resin, a phenol novolac epoxy resin, a cresol novolac epoxy resin, a rubber modified epoxy resin, a phosphorus based epoxy resin, and a bisphenol F type epoxy resin is used.

As the silicon based resin, SiO₂, SiNx, silane based compounds, and a combination thereof is used. According to at least one embodiment, the interposing layer 510 formed of the silicon based resin has a refractive index of 1.2 to 1.6 and a transmittance ranging from 30 to less than 99% in the visible light region, such that the interposing layer 510 is easily prepared as the low refractive index layer, and whiteness is improved.

Meanwhile, in the application embodiment of the invention, the interposing layer 510 is formed of an oxide film. Meanwhile, the interposing layer 510 formed of the oxide film is formed between the reflecting layer 505 and the bezel layer 520. In other words, the interposing layer is formed of the oxide film instead of the transparent resin material. According to at least one embodiment, the oxide film is formed of a material having a refractive index lower than that of the bezel layer 520.

According to at least one embodiment, the oxide film is formed of an oxide of any one selected from titanium (Ti), aluminum (Al), nickel (Ni), silver (Ag), chromium (Cr), platinum (Pt), molybdenum (Mo), copper (Cu), gold (Au), tungsten (W), iridium (Ir), and a combination thereof.

According to at least one embodiment, the oxide film as described above is formed of a material having a refractive index of 1.2 to 2 in the visible light region and a transmittance ranging from 50% to less than 99%, wherein the refractive index is less than that of the bezel layer 520.

As described above, the touch sensor 5 in which the bezel layer 520, which is the high refractive index layer, the interposing layer 510, which is the low refractive index layer, and the reflecting layer 505 formed of the reflecting material are sequentially laminated on the bezel area B improves whiteness of the bezel area B due to the difference in the refractive index.

Describing in more detail, in order to implement bright colors of a bezel, whiteness of the bezel area B needs to be increased. As a method of increasing the whiteness as described above, a method of increasing the reflectivity is used. When among Commission Internationale de l'Eclairage (CIE) L*a*b* values, a luminosity (L*) value is high but a* and b* values are close to 0, the color is seen as a white color by human eyes. Here, the luminosity (L*) value indicates a degree of reflection.

In addition, as another method of increasing whiteness, as the light incident on a medium is further scattered, the higher whiteness is implemented. As a method of increasing the scattering, a medium having a large difference in the refractive index is required. Further, in this case, it is preferable that a transparent material is used as a material having a low refractive index.

Therefore, the interposing layer 510 having a low refractive index is interposed between the reflecting layer 505 and the bezel layer 520, such that the scattered light is increased, thereby making it possible to further improve whiteness of the bezel area B.

In addition, in order to implement various colors of the bezel layer 520, particularly, a bright color like a white color, there is a difference according to the material, but a thicker bezel layer 520 is generally required. In the case in which all of the lights are transmitted through the bezel layer 520, it is difficult for a user to see the color of the bezel layer 520.

Therefore, in order to implement the bezel layer 520 having a color such as a white color, there was a problem in that the thickness of the bezel layer 520 should be thick unlike the case of implementing other colors through which light does not well pass.

However, the bezel layer 520 of the touch sensor according to the application embodiment of the invention is formed of a thin film, the refractive index and transmittance is adjusted, and the reflecting layer 505 is included on one surface of the bezel layer 520, such that even in the case of forming the bezel layer 520 in a thin film shape, colors of the bezel layer 520 is more vividly and effectively implemented.

Hereinafter, embodiments of the invention will be described with reference to the Examples and Comparative Examples in detail, but the present invention is not limited thereto.

### Example 1

### Preparation of Composite Powder

Preparation of Core Layer

A core layer 105 was formed using an aluminum (Al) metal, and spherical powder having reflectivity at 60 to 99% was prepared. In this case, as the spherical powder, powder having an average size of 50 to 100 nm was classified using a mesh.

Formation of First Coating Layer

In order to form a first coating layer 110, an aqueous solution capable of dispersing the core powder was prepared, and the aluminum powder, which was the core powder, was dispersed in the aqueous solution, thereby forming slurry. In this case, 1 to 5 parts by weight of the core powder is dispersed in the slurry.

In addition, 12 to 25 parts by weight of tetraethoxysilane (TEOS)-ethanol solution was added to the slurry in which the aluminum powder was dispersed, thereby forming the first coating solution. In this case, the first coating solution may have a pH of 10 to 12 and be stirred at 50 to 75° C. The first coating solution formed the first coating layer 110 formed of silicon oxide (SiO₂) through hydrolysis. In this case, the first coating layer 110 formed of silicon oxide may have a refractive index of 1.3 to 1.5.

Formation of Second Coating Layer

An aqueous solution of an inorganic acid salt (for example, of the titanyl sulfate) of titanium was prepared, and the powder in which the first coating layer was formed on a surface of the core layer was added thereto, thereby precipitating titanium dioxide hydrate on surfaces of core particles of the first coating layer 110 in the aqueous solution of the inorganic salt of titanium. The second coating layer is formed by a method of heating and reducing the titanium dioxide coated powder prepared as described above at 500 to 1000° C. with a reducible flame using gas having reducing powder. In this case, as the gas having reducing power, hydrogen gas, ammonia gas, as non-limiting examples, is used, and a mixed gas of the gas having reducing power and inert gas such as helium gas, argon gas, nitrogen gas, as non-limiting examples, was used.

Preparation of Pigment Paste

A pigment paste was prepared by mixing 80 g of the composite powder, 19 g of a thermosetting resin (ester based polyol+isocyanate curing agent), 30 g of a solvent (isophorone), 0.8 g of a dispersant (PB821), 0.3 g of another antifoaming agent (BYK057), and 0.3 g of a leveling agent (BYK361n) with each other. Here, the composite powder was formed of spherical powder having a three layer structure, and particles having a size of 300 to 500 nm were used.

Manufacturing of Touch Sensor

Formation of Bezel Layer

A glass substrate was used as a window substrate 550, and the prepared pigment paste 4 was used on the glass substrate. The pigment paste 4 was coated one time by a screen printing method to form a bezel layer 520 having a thickness of 6 to 9 μm, and the formed bezel layer 520 was dried. Here, the bezel layer 520 was formed of a single layer on an edge region of the window substrate 520.

### Example 2

### Manufacturing of Touch Sensor

Formation of Interposing Layer

An interposing layer was formed so as to have a thickness of 1 to 8 μm by coating silicon oxide (SiO₂) on an edge portion of the window substrate 550 on which the bezel layer 520 using the pigment paste 4 containing the composite powder 1 in Example 1 was formed.

Formation of Reflecting Layer

After forming the interposing layer 510, a reflecting layer 505 was formed by printing a paste containing aluminum (Al) powder on the interposing layer 510 using a screen printing method.

### Comparative Example 1

### Preparation of Titanium Oxide Powder

Unlike the composite powder in Example 1, in Comparative Example 1, powder was formed only using titanium oxide powder. In order to obtain titanium oxide, sodium titanate was prepared, suspended particles of titanium oxide from the acid was purified, and the acid was recovered using a centrifuge. A pH of the suspended material as a lump of the titanium oxide obtained as described above was increased to thereby be neutralized. In addition, the neutralized lump was hydrothermally treated, thereby forming titanium oxide particles.

Preparation of Titanium Oxide Paste

In Comparative Example 1, a titanium oxide paste was prepared using the titanium oxide powder instead of the composite powder 1 at the time of preparing the pigment paste 4 in Example 1. Other conditions were the same as those in Example 1.

Manufacturing of Touch Sensor

Formation of Bezel Layer

A bezel layer was formed of a single layer on an edge region of a window substrate using the titanium oxide paste by a screen printing method as in Example 1. In this case, the bezel layer was formed at a thickness of 6 to 9 μm.

### Comparative Example 2

### Formation of Interposing Layer

In Comparative Example 2, an interposing layer was formed on the bezel layer formed of titanium oxide in Example 1. In this case, the interposing layer was formed by the same method in Example 2.

Formation of Reflecting Layer

A reflecting layer was formed on the interposing layer. In this case, the reflecting layer was formed by the same method in Example 2.

Measurement of Thickness and Whiteness of Bezel Layer

Samples were prepared by cutting the touch sensors obtained in the Examples 1 and 2 and the Comparative Examples 1 and 2 so that cross-sections of the bezel layers were shown. In addition, the thickness of the bezel layer was measured by measuring a thickness of the cut cross-section using a scanning electron microscope (SEM). Further, whiteness of the bezel area was measured using a UV/VIS spectrum.

TABLE 1

| | The | | |
|---|---|---|---|
| | number of | | |
| Sample | layer | Thickness (μm) | Whiteness (L*) |
| Example 1 | 1 | 6.21 | 82.0 |
| Comparative | 1 | 7.08 | 71.8 |
| Example 1 | | | |
| Example 2 | 3 | 11.20 | 85.2 |
| Comparative | 3 | 23.33 | 77.6 |
| Example 2 | | | |

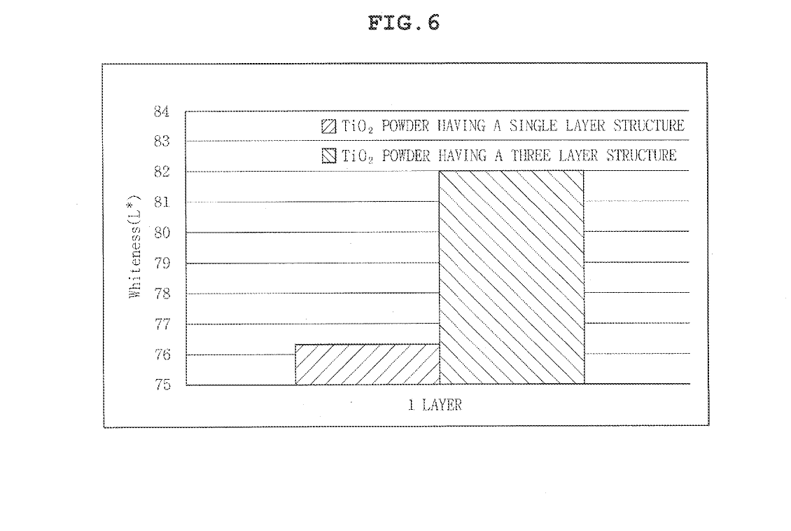

FIG. 6 is a graph showing measured whiteness of samples according to another embodiment of the invention.

Referring to FIG. 6 and Table 1, in Comparative Examples 1 and 2, firstly, the bezel layer made of only the titanium dioxide (TiO₂) powder according to the conventional art was formed of the single layer, and the more the number of layers of the bezel layer, the higher the whiteness.

In Comparative Example 1, the bezel layer formed using the titanium oxide powder according to the prior art was configured of the single layer, and the measured thickness and whiteness thereof were 7.08 μm and 71.8, respectively. Thus, it was judged that the bezel layer was formed of the single layer to thereby be thinned, but the whiteness was low, such that the bezel was not suitable for being used as a white bezel.

In Comparative Example 2, the bezel region was configured of three layers, and the measured thickness and whiteness thereof were 23.33 μm and 77.6, respectively. Therefore, since the bezel layer was formed of the three layers, at the time of comparing Comparative Example 1 with each other, it was measured that the higher the thickness, the higher the whiteness. In Comparative Example 2, the whiteness was increased, such that it was judged that the bezel was suitable for being used as a bright colored bezel. However, in Comparative Example 2, the whiteness was improved but the thickness was thick, such that it was difficult to implement thinness.

Therefore, it may be appreciated that in order to improve whiteness, the bezel layer needs to be formed of plural layers and have a predetermined thickness. For example, according to the conventional art, in order to improve whiteness, a plurality of bezel layers were used, and the bezel layer having a thickness of 30 to 50 μm was required. As described above, the thick thickness of the bezel layer may improve whiteness, but it is difficult to implement thinness due to the thick thickness.

Meanwhile, comparing Comparative Example 1 and Example 1 with reference to FIG. 6 and Table 1, the bezel layer was formed of a single layer using the powder made of titanium dioxide (TiO₂) according to the conventional art in the Comparative Example, and the bezel layer 520 was formed of a single layer using the composite powder 1 according to at least one embodiment of the invention in Example 1.

As shown in Table 1, in Comparative Example 1, the measured thickness and whiteness were 7.08 μm and 71.8, respectively, and in Example 1, the measured thickness and whiteness were 6.21 μm and 82.00, respectively. The reason is that in the composite powder 1 according to the present invention, since the second coating layer 120, that is, the TiO₂ layer covered on the first coating layer 110 and the core layer 105, the core layer 105 formed in the second coating layer reflected visible light, and the light was introduced into the second coating layer 120 due to the difference in the refractive index generated between the first coating layer 110 and the second coating layer 120, such that the scattering effect was increased, thereby increasing whiteness.

Therefore, even though the bezel layer 520 containing the composite powder 1 is formed of the single layer, the whiteness is improved, such that even in the case of forming a single bezel layer rather than a plurality of bezel layers, the whiteness is increased, thereby making it possible to decrease the thickness of the bezel. Further, the bezel layer 520 using the composite powder 1 is formed to have a thickness thinner than that of the bezel layer using titanium dioxide according to the conventional art.

Meanwhile, comparing Example 2 and Comparative Example 2 with each other, in Example 2, the bezel in which the bezel layer 520, the interposing layer 510, and the reflecting layer 505 were sequentially laminated on the window substrate 550 to thereby be configured of three layers was formed. Further, in the Comparative Example 2, the bezel layer was formed using general titanium dioxide powder, and the interposing layer and reflecting layer were formed on the bezel layer, thereby forming the bezel.

It was measured that formation thickness and whiteness characteristics were improved in Example 2 and Comparative Example 2, respectively, such that the bezel had characteristics suitable for being used as a white bezel.

It is judged that in Example 2 and Comparative Example 2, the whiteness was increased due to the difference in the refractive index between the interposing layer 510 and the bezel layer 520. Further, it is judged that the reflecting layer 505 was further formed on the interposing layer 510 to reflect the light to be discharged to the outside of the bezel layer 520 toward the bezel layer 520 again, such that light remaining in the bezel layer 520 was further scattered, thereby improving the whiteness.

Describing in more detail, in Example 2, the bezel layer 520 was formed using the pigment paste 4 containing the composite powder 1, and the interposing layer 510 was formed so that a thickness thereof was 40% of the thickness of the bezel layer 510. Further, the reflecting layer 505 was formed to have the same thickness as that of the interposing layer 520. Therefore, the measured thickness of the bezel in Example 2 was 11.2 μm.

On the other hand, in Comparative Example 2, the titanium oxide paste was prepared using the titanium oxide powder according to the conventional art, and the bezel layer was formed on the bezel area using the titanium oxide paste. Further, the interposing layer and the reflecting layer were formed on the bezel layer, and the measured thickness was 23.33 μm.

As described above, it may be appreciated that even though the bezel was formed of three layers in Example 2, the bezel was formed to be thinner as compared to the bezel in Comparative Example 2. It is judged that since starting materials in Example 2 and Comparative Example 2 were different from each other, the thicknesses of the formed bezels were different from each other.

In addition, the measured whiteness of the bezel in Example 2 was 85.2, and the measured whiteness of the bezel in Comparative Example 2 was 77.6. Thus, even though the bezel formed in Example 2 had the thinner thickness, the whiteness was further improved as compared to the bezel in Comparative Example 2.

In other words, it is judged that the bezel was configured of three layers, that is, the bezel layer 520, the reflecting layer 505, and the interposing layer 510, as in Example 2, such that the whiteness was improved due to the difference in the refractive index between the bezel layer 520 and the interposing layer 510 and the reflection effect of the reflecting layer 505. The reason is that the light incident from the outside was allowed to remain in the bezel layer 520 for a long time by the difference in the refractive index between the bezel layer 520 and the interposing layer 510, thereby improving the whiteness.

Therefore, considering that in Example 2, the bezel was thin and the measured whiteness was increased, it is judged that the composite powder 1 improves the whiteness, and the bezel was formed in a structure using the difference in the refractive index and the reflecting effect as in the composite powder 1, such that the whiteness of the bezel was further improved.

As described above, comparing Example 2 and Comparative Example 2, the bezel formed using the composite powder 1 was thin, and the whiteness thereof was improved. Therefore, it is appreciated that the composite powder 1 had more excellent efficiency in forming the bright colored bezel.

In addition, as the thin the bezel layer is implemented, an electric short-circuit problem by a step between an electrode pattern and electrode wiring in a structure of a touch sensor in which the electrode pattern is formed on the window substrate including the bezel layer is solved, such that the touch sensor is more stably operated.

According to various embodiments of the invention, the first coating layer, which is the low refractive index layer, is interposed between the core layer made of the reflecting material at the center of the composite powder and the second coating layer, which is the high refractive index layer, such that the composite powder implements bright colors of which whiteness is improved by increasing the scattering of visible light and the reflection effect of the core layer.

Furthermore, according to various embodiments of the invention, whiteness which it is difficult to implement in a thin film is more effectively improved using the composite powder.

In addition, according to various embodiments of the invention, the bezel layer and the reflecting layer of the touch sensor are laminated together with each other using the composite powder, such that even in the bezel layer in a thin film shape, colors are effectively implemented.

Furthermore, according to various embodiments of the invention, colors of the bezel layer is more variously and vividly implemented by adjusting a coupling thickness of the interposing layer and the reflecting layer coupled to each other in addition to the coupling structure of the interposing layer coated on the bezel layer and the reflecting layer coupled thereto.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A composite powder, comprising:
a core layer formed at the center thereof;
a first coating layer formed on a surface of the core layer; and
a second coating layer formed on a surface of the first coating layer and comprising a refractive index higher than that of the first coating layer.

2. The composite powder as set forth in claim 1, wherein diameters of the core layer and the first and second coating layers are 300 to 500 nm.

3. The composite powder as set forth in claim 1, wherein a thickness of the first coating layer is 10 to 40% of a thickness of the formed second coating layer.

4. The composite powder as set forth in claim 1, wherein the core layer comprises a diameter of 50 to 100 nm.

5. The composite powder as set forth in claim 1, wherein reflectivity of the core layer is 60 to 99%.

6. The composite powder as set forth in claim 1, wherein the core layer is formed of any one selected from the group consisting of titanium (Ti), aluminum (Al), nickel (Ni), silver (Ag), chromium (Cr), platinum (Pt), molybdenum (Mo), copper (Cu), gold (Au), tungsten (W), iridium (Ir), and a combination thereof.

7. The composite powder as set forth in claim 1, wherein the first coating layer is formed on the surface of the core layer at a thickness of 20 to 100 nm.

8. The composite powder as set forth in claim 1, wherein a transmittance of the first coating layer in a visible light region is 30 to 99%.

9. The composite powder as set forth in claim 1, wherein a refractive index of the first coating layer is 1.2 to 2.

10. The composite powder as set forth in claim 1, wherein the first coating layer is formed of any one selected from the group consisting of SiO₂, SiNx, silane based compounds, and a combination thereof.

11. The composite powder as set forth in claim 1, wherein the first coating layer is formed of an oxide of any one selected from the group consisting of titanium (Ti), aluminum (Al), nickel (Ni), silver (Ag), chromium (Cr), platinum (Pt), molybdenum (Mo), copper (Cu), gold (Au), tungsten (W), iridium (Ir), and a combination thereof.

12. The composite powder as set forth in claim 1, wherein the second coating layer is formed on the surface of the first coating layer at a thickness of 150 to 300 nm.

13. The composite powder as set forth in claim 1, wherein reflectivity of the second coating layer in a visible light region is 50 to 95%.

14. The composite powder as set forth in claim 1, wherein reflectivity of the second coating layer in a visible light region is 75 to 90%.

15. The composite powder as set forth in claim 1, wherein a refractive index of the second coating layer is 2 to 3.

16. The composite powder as set forth in claim 1, wherein the second coating layer is formed of any one selected from the group consisting of titanium dioxide (TiO₂), hafnium oxide (HfO₂), and a combination thereof or any one selected from zinc oxide (ZnO), magnesium oxide (MgO), cerium oxide (ceria; Ce₂O₃), indium oxide (In₂O₃), indium tin oxide (ITO), barium titanate (BaTiO₃), potassium tantalate (KTaO₃), (Ba,Sr)TiO₃, and a combination thereof.

17. A pigment paste, comprising:
a resin composition; and
the composite powder, as set forth in claim 1, dispersed in the resin composition.

18. The pigment paste as set forth in claim 17, wherein the resin composition comprises a binder, a solvent, and an additive.

19. A touch sensor, comprising:
a window substrate; and
a bezel layer formed at an edge portion of the window substrate and comprising the composite powder as set forth in claim 1.

20. The touch sensor as set forth in claim 19, further comprising:
a reflecting layer formed on the bezel layer; and
an interposing layer between the bezel layer and the reflecting layer,
wherein the interposing layer is formed of a material having a refractive index lower than that of the bezel layer.

21. The touch sensor as set forth in claim 20, wherein a lamination thickness of the bezel layer, the reflecting layer, and the interposing layer is 2 to 50 μm.

22. The touch sensor as set forth in claim 19, wherein a thickness of the bezel layer is 1 to 20 μm.

23. The touch sensor as set forth in claim 19, wherein reflectivity of the bezel layer in a visible light region is 50 to 95%.

24. The touch sensor as set forth in claim 19, wherein reflectivity of the bezel layer in a visible light region is 75 to 90%.

25. The touch sensor as set forth in claim 19, wherein a refractive index of the bezel layer is 2 to 3.

26. The touch sensor as set forth in claim 20, wherein a thickness of the interposing layer is 10 to 40% of a thickness of the bezel layer.

27. The touch sensor as set forth in claim 20, wherein a thickness of the interposing layer is 1 to 8 μm.

28. The touch sensor as set forth in claim 20, wherein the interposing layer is formed of any one selected from the group consisting of a transparent acrylic resin, a silicon based resin, and an epoxy resin, and a combination thereof.

29. The touch sensor as set forth in claim 28, wherein the silicon based resin is any one selected from the group consisting of SiO₂, SiNx, silane based compounds, and a combination thereof.

30. The touch sensor as set forth in claim 20, wherein the interposing layer is formed of an oxide of any one selected from the group consisting of titanium (Ti), aluminum (Al), nickel (Ni), silver (Ag), chromium (Cr), platinum (Pt), molybdenum (Mo), copper (Cu), gold (Au), tungsten (W), iridium (Ir), and a combination thereof.

31. The touch sensor as set forth in claim 20, wherein a transmittance of the interposing layer in a visible light region is 30 to 99%.

32. The touch sensor as set forth in claim 20, wherein a refractive index of the interposing layer is 1.2 to 2.

33. The touch sensor as set forth in claim 20, wherein a thickness of the reflecting layer is 1 to 20 μm.

34. The touch sensor as set forth in claim 20, wherein reflectivity of the reflecting layer is 60 to 99%.

35. The touch sensor as set forth in claim 20, wherein the reflecting layer is formed of any one selected from the group consisting of titanium (Ti), aluminum (Al), nickel (Ni), silver (Ag), chromium (Cr), platinum (Pt), molybdenum (Mo), copper (Cu), gold (Au), tungsten (W), iridium (Ir), and a combination thereof.
